(19) United States
(12) Patent Application Publication
(10) Pub. No.: US 2017/0331795 A1
(43) Pub. Date: Nov. 16, 2017

(54) VEHICLE DATA ENCRYPTION

(71) Applicant: Ford Global Technologies, LLC, Dearborn, MI (US)

(72) Inventors: Douglas Raymond MARTIN, Canton, MI (US); Kenneth James MILLER, Canton, MI (US); Mark Anthony ROCKWELL, Wyandotte, MI (US)

(21) Appl. No.: 15/154,085

(22) Filed: May 13, 2016

(51) Int. Cl. H04L 29/06; H04L 9/08; G06F 9/445; B60R 16/023; H04W 12/02; H04L 29/08

(52) U.S. Cl. CPC H04L 63/0428; H04W 12/02; H04L 67/34; G06F 8/65; B60R 16/023; H04L 9/0861; H04L 2209/80; H04L 2209/84

(57) ABSTRACT

A wireless communication system includes a server, in communication with a vehicle controller. The server, in response to receiving from the controller a software update request including a timestamp, identifies a long key associated with the vehicle, encrypts the update beginning at a key offset into the long key generated from a manipulation of a data ordering of the timestamp, and transmits the encrypted update to the controller. A controller, in communication with a server, in response to receiving from the server an encrypted software update triggered by an update request transmitted by the controller and including a timestamp, identifies a long key associated with the vehicle, decrypts the update beginning at a key offset into the long key generated from a manipulation of data ordering of the timestamp, and initiates an installation of the decrypted update on the vehicle.

### TECHNICAL FIELD

The present disclosure relates to systems and methods for encrypting software update for a vehicle using a manipulated timestamp value.

### BACKGROUND

A vehicle may include one or more controllers configured to monitor and manage vehicle operating characteristics, such as, but not limited to, a powertrain controller, infotainment system controller, climate control system controller, fuel system controller and so on. The controllers may include hardware and software components. In one example, the software components may benefit from periodic software updates whether conducted using a wired or a wireless connection.

### SUMMARY

A wireless communication system includes a server, in communication with a controller of a vehicle, configured to, in response to receiving from the controller a software update request including a timestamp, identify a long key associated with the vehicle, encrypt the update beginning at a key offset into the long key generated from a manipulation of a data ordering of the timestamp, and transmit the encrypted update to the controller.

A method includes in response to receiving a request from a controller of a vehicle for a software update, identifying, by a server, a long key associated with the vehicle, encrypting the update using data at a key offset into the long key, the key offset computed from a reordering of data elements of a timestamp of the request, and sending the encrypted update to the controller.

A system for a vehicle includes a controller, in communication with a server, configured to, in response to receiving from the server an encrypted software update triggered by an update request transmitted by the controller and including a timestamp, identify a long key associated with the vehicle, decrypt the update beginning at a key offset into the long key generated from a manipulation of data ordering of the timestamp, and initiate an installation of the decrypted update on the vehicle.

### BRIEF DESCRIPTION OF THE DRAWINGS

FIG. 1 is a block diagram illustrating an example communication system for providing a software update to a vehicle;

FIG. 2 is a block diagram illustrating a software update encryption and decryption system;

FIG. 3 is a block diagram illustrating a key offset into a long key for encryption and decryption of the software update;

FIG. 4A-4C are block diagrams illustrating manipulation of a timestamp value for encryption and decryption of the software update;

FIG. 5 is a flowchart illustrating an algorithm for encryption of the software update by the update server; and

FIG. 6 is a flowchart illustrating an algorithm for decryption of the software update by the vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

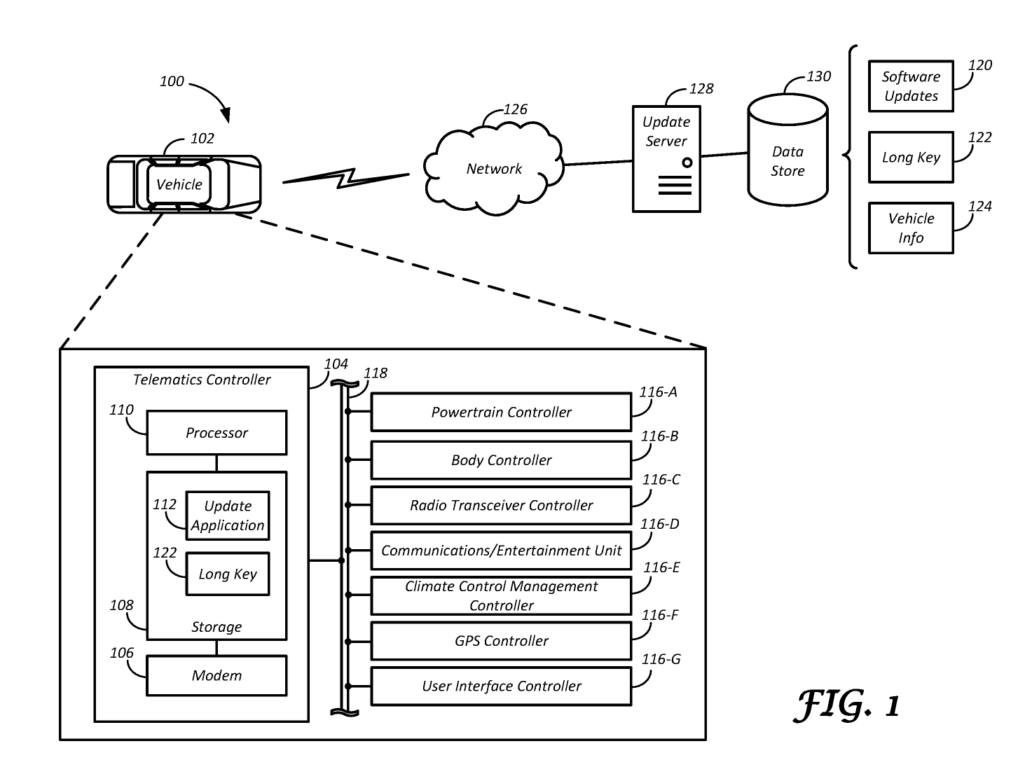

FIG. 1 illustrates an example system 100 for providing software updates 120 to a vehicle 102. The system 100 may include a telematics controller 104 having a modem 106 in communication over a network 126 with an update server 128 (e.g., directly, or via a mobile device of a vehicle occupant). The update server 128 may communicate with a data store 130 configured to maintain software updates 120 for download, as well as long keys 122 associated with vehicle information 124 and used for encryption of the software update 120. The system 100 may further include an update application 112 installed to the vehicle 102 and configured to install software updates 120 to the telematics controller 104 itself or to other controllers 116 of the vehicle 102. While an example system 100 is shown in FIG. 1, the example components illustrated in the Figure are not intended to be limiting. Indeed, the system 100 may have more or fewer components, and additional or alternative components and/or implementations may be used.

The vehicle 102 may include various types of automobile, crossover utility vehicle (CUV), sport utility vehicle (SUV), truck, recreational vehicle (RV), boat, plane or other mobile machine for transporting people or goods. In many cases, the vehicle 102 may be powered by an internal combustion engine. As another possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). As the type and configuration of vehicle 102 may vary, the operating characteristics of the vehicle 102 may correspondingly vary. As some other possibilities, vehicle 102 may have different characteristics with respect to passenger capacity, towing ability and capacity, and storage volume.

The one or more other controllers 116 (represented as discrete controllers 116-A through 116-G) may be configured to monitor and manage various vehicle 102 functions under the power of the vehicle battery and/or drivetrain. While the controllers 116 are illustrated as separate components the vehicle controllers 116 may share physical hardware, firmware, and/or software, such that the functionality from multiple controllers 116 may be integrated into a single controller 116, and that the functionality of various such controllers 116 may be distributed across a plurality of controllers 116. The controllers 116 may include various vehicle 102 components configured to receive updates of associated software, firmware, or configuration settings.

The vehicle controllers 116 may, for example, include, but are not limited to, a powertrain controller 116-A configured to manage engine operating components, a body controller 116-B configured to manage various power control functions such as exterior lighting, interior lighting, keyless entry, remote start, and point of access status verification, a radio transceiver controller 116-C configured to communicate with key fobs, mobile devices, or other local vehicle 102 devices, an entertainment controller 116-D configured to support voice command and BLUETOOTH interfaces with the driver and driver carry-on devices, a climate control management controller 116-E configured to monitor and manage heating and cooling system components (e.g., compressor clutch, blower fan, temperature sensors, etc.), a global positioning system (GPS) controller 116-F configured to provide vehicle location information, and a human-machine interface (HMI) controller 116-G configured to receive user input via various buttons or other controls, as well as provide vehicle status information to a driver.

The vehicle bus 118 may include various methods of communication available between the vehicle controllers 116, as well as between the telematics controller 104 and the vehicle controllers 116. The vehicle bus 118 may further include one or more of a vehicle controller area network (CAN), an Ethernet network, and a media oriented system transfer (MOST) network.

The telematics controller 104 may include one or more processors 110 (e.g., microprocessors) configured to execute firmware or software programs stored on one or more storage devices 108 of the telematics controller 104. The telematics controller 104 may further include network hardware configured to facilitate communication between the vehicle controllers 116 and with other devices of the system 100. For example, the telematics controller 104 may include a cellular modem 106 configured to facilitate communication with the communication network 126. The network 126 may include one or more interconnected communication networks such as the Internet, a cable television distribution network, a satellite link network, a local area network, a wide area network, and a telephone network, as some non-limiting examples. As another example, the telematics controller 104 may be configured to communicate via one or more of Bluetooth, Wi-Fi, and wired USB network connections and facilitate data transmission between the network 126 and a mobile device.

The vehicle information 124 may include information configured to identify the vehicle 102 or the configuration of the vehicle 102. For example, the vehicle information 124 may include a vehicle identification number (VIN) published to the vehicle bus 118, or subscriber identity module (SIM) information of the modem 106 such as international mobile station equipment identity (IMEI). Additionally or alternately, the vehicle information 124 may include version information for at least a portion of the hardware and software components of the vehicle controllers 116 of the vehicle 102.

The software updates 120 may include changes to the software or settings of the vehicle 102 to address an issue with the current software or settings, or to provide improved functionality to the current software. The software updates 120 may include, for example, updated configuration settings for one or more vehicle controllers 116, and/or updated versions of software or firmware to be installed on one or more vehicle controllers 116. In some cases the software updates 120 may include a single data segment, while in other cases the software updates 120 may be organized into multiple segments, elements, or chunks, all of which may need to be downloaded in order to complete the overall software update 120 to be installed.

The data store 130 may be configured to store the software updates 120. The data store 130 may be further configured to store additional information regarding the software updates 120. For example, the data store 130 may be configured to identify which vehicle controllers 116 are associated with which software updates 120. The data store 130 may further store information indicative of the compatibility of the software updates 120 with specifications of the vehicle 102. For instance, a storage entry for the software update 120 may indicate that the software update 120 is compatible with a particular make and model of the vehicle 102, or that it is associated with a particular version(s) of the vehicle controller 116.

The software update 120 may in some cases begin with a plurality of leading zeros or have other characteristics making it easier to identify during transmission between the update server 128 and the vehicle 102 and potentially exposing it to tempering. The data store 130 may be further configured to store the long key 122 used for encryption of the software updates 120. The long key 122 may include a random string of bytes or other information shared by the data store 130 and the vehicle 102. In some cases, the long key 122 may be maintained both in the storage device 108 of the telematics controller 104 of the vehicle 102, and in the data store 130 indexed according to vehicle information 124, e.g., VIN provided to the data store 130 as part of the vehicle information 124.

The update server 128 may include one or more devices configured to transmit to the vehicle 102 the software updates 120 stored by the data store 130. For example, the update server 128 may be configured to receive requests for available software updates 120 from the vehicle 102. The requests may include the vehicle information 124 allowing the update server 128 to query the data store 130 for the software updates 120 associated with the vehicle 102 as it is currently configured. The update server 128 may provide, responsive to the requests, indications of the available software updates 120 (or the software updates 120 themselves) to update the requesting vehicle 102. The update server 128 may be further configured to encrypt the software updates 120 using the long key 122, and provide encrypted software updates 120′ to devices requesting to download the software updates 120.

The update application 112 may be configured to manage the installation of the software updates 120 to the vehicle 102. For example, the update application 112 may receive a command from a user indicative of a request to check for the software updates 120. As another possibility, the update application 112 may trigger a periodic check for new software updates 120. When triggered, the update application 112 may be configured to send an update request to the update server 128 to inquire whether software updates 120 for the vehicle 102 are available. For example, the update application 112 may query the update server 128 using the vehicle information 124 (or, if the data store 130 maintains current vehicle information 124, an identifier of the vehicle 102), and may receive a response from the update server 128 indicative of whether new software updates 120 for the vehicle 102 are available (e.g., as links or other identifiers of the software updates 120 for the vehicle 102 to download). If the response to the update application 112 indicates the software updates 120 are available for the vehicle 102, the update application 112 may be further configured to download and install the indicated updates, or in other cases queue the software updates 120 to be downloaded and installed.

The update application 112 may be configured to facilitate the downloading of the software updates 120 to the vehicle 102. For instance, the update application 112 may be configured to receive a listing of the software update 120 identified by the update server 128 as being available for download and install. The update application 112 may be further configured to detect when the vehicle 102 is connected to the network 126, e.g., via the modem 106, and perform downloading of the software update 120 when connected.

The update application 112 may be further configured to facilitate the decryption and installation of the downloaded encrypted software updates 120′. For example, the update application 112 may be configured to decrypt the downloaded encrypted software updates 120′ according to the long key 122 maintained by the vehicle 102 and used to encrypt the software updates 120 for transport between the vehicle 102 and the update server 128.

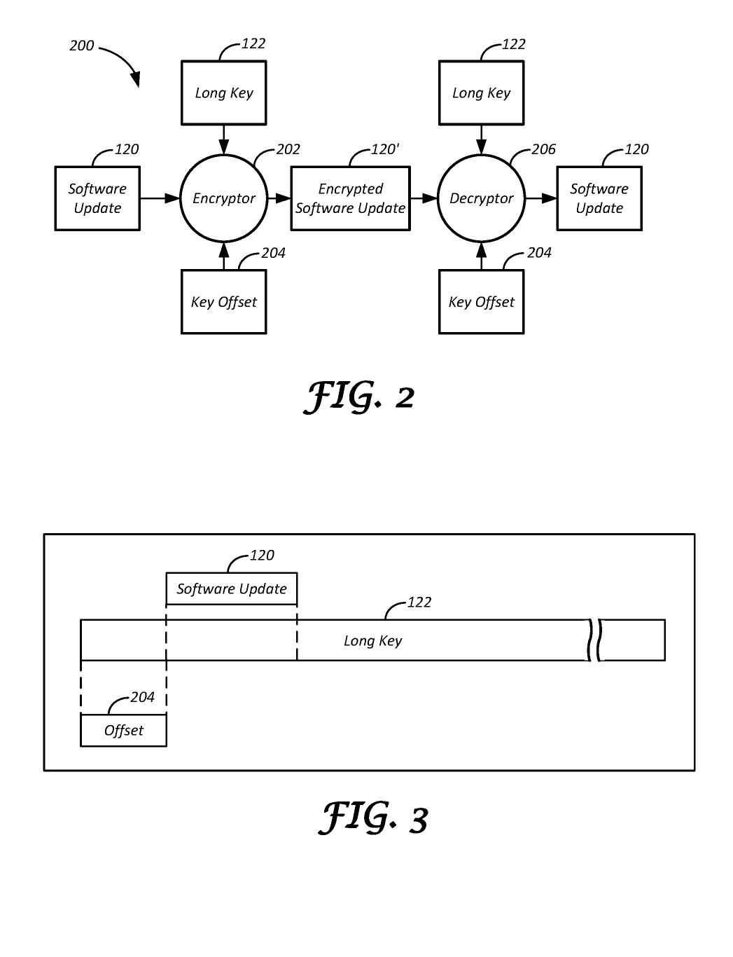

FIG. 2 illustrates an example diagram 200 of encryption and decryption of the software update 120. As shown, an encryptor 202 may be configured to generate an encrypted software update 120′ using the software update 120, the long key 122, and a key offset 204 into the long key 122. Moreover, a decryptor 206 may be configured to regenerate the original software update 120 using the encrypted software update 120′, the long key 122, and the key offset 204. In an example, the update server 128 may perform the operations of the encryptor 202 on the software update 120 before providing the encrypted software update 120′ to the vehicle 102, and the update application 112 may perform the operations of the decryptor 206 on the received encrypted software updates 120′ prior to installation to the vehicle 102.

The update server 128 may identify the long key 122 associated with the vehicle 102, e.g., based on the vehicle information 124 included in the update request received from the vehicle 102. In an example, the update server 128 may retrieve the long key 122 from the data store 130 according to a VIN of the vehicle 102 included in the vehicle information 124 of the update request. Prior to transmission of the requested software update 120 to the vehicle 102, the update server 128 may encrypt the software update 120 using the long key 122 associated with the vehicle 102. In one example, the update server 128 may combine a single segment of the long key 122, such as a first segment, with a single, e.g., first, segment of the software update 120.

Rather than using the first segment of the long key 122 to encrypt the software update 120, the update server 128 may determine the key offset 204 into the long key 122, as shown, for example, in FIG. 3. In an example, the update server 128 may determine the key offset 204 into the long key 122 based on a timestamp value included in the received update request. The timestamp value may be a value known to both the vehicle 102 and the update server 128 and may represent, for example, a date and time the update request was transmitted from the vehicle 102. In an example, the update server 128 may use the timestamp value to generate a number that may be used as an offset into the long key 122. By using the key offset 204, the update server 128 may avoid repeatedly using initial portions of the long key 122 for encryption and decryption operations.

The timestamp value included with the request for the software update 120 may be expressed in a variety of formats, such as, but not limited to, format conforming with International Organization for Standardization (ISO) 8601 standard, portable operating system interface (POSIX) standards, and other domestic and/or international standards for information interchange. In one example, the timestamp value may be expressed using a time system describing a number of seconds elapsed since a predetermined epoch time, e.g., since 00:00:00 coordinated universal time (UTC), Jan. 1, 1970. Thus the timestamp value defining an example date and time of 2014-11-16T14:10:26Z, i.e., 14:10:26 on Oct. 16, 2014 UTC, may be 1416147026 or a decimal number of seconds elapsed between 00:00:00 UTC and the example date and time.

In response to receiving an update request including a timestamp value, the update server 128 may perform one or more operations verifying the request. For instance, the update server 128 may verify that the received request is authorized, e.g., the request originated from the vehicle 102 that is an authorized vehicle. In an example, the update server 128 may compare the received timestamp value to the timestamp values included in previous update requests and accept the received update request if the received timestamp value differs from timestamp value associated with the previous update requests (e.g., to avoid cases where the timestamp may be being reused by an illegitimate user). In another example, the update server 128 may determine a difference in time between the received timestamp value and the timestamp value included with a previous update request and accept the received update request in response to a difference being less than a threshold difference in time (e.g., to ensure that the time difference is reasonable for the processing time and/or location of the vehicle). As yet a further example, the update server 128 may confirm that the timestamp value is within a predetermined threshold amount of time from the current time at the server (e.g., to avoid requests involving clearly manufactured or replayed timestamp values). The above described verifications and checks are non-limiting and may be performed individually, cumulatively, and/or in addition to other verification operations. Likewise, other verification schemes, such as those using vehicle identifying information and stored with the vehicle information 124, are also contemplated.

In one instance, the long key 122 may be represented as an array of bytes and the key offset 204 may be a byte index into the array. In that case, the update server 128 may be configured to determine the key offset 204 by translating the timestamp value into a byte array index. The update server 128 may, for example, scale the timestamp value to a length of the long key 122 using a scale factor, perform one or more modular arithmetic operations, or apply another computing or arithmetic process to the timestamp value. The update server 128 may use a byte of the long key 122 at the key offset 204 as a first byte to use for the encryption and decryption operations.

The update server 128 may manipulate the timestamp value prior to determining the key offset 204. This may be done, for example, to adjust which bits in the timestamp value are most significant in generating the key offset 204. In one example, the update server 128 may convert the data representation of the timestamp value into a binary string of 1s and 0s. In such an example, the update server 128 may further rearrange the individual bit elements of the binary string according to a predetermined reordering or rearranging procedure, thereby generating the key offset 204 into the long key 122. In another example, the update server 128 may convert the data representation of the timestamp value into a string of values including multiple bits (e.g., two bits, four bits, bytes, decimal digits, etc.) and may reverse the ordering of each of those values. Manipulation of the timestamp value to generate the key offset 204 may thus protect the same portion of the long key 122 from being exposed during data transmissions that are close together in time, e.g., several seconds apart. For instance, the reordering procedure may avoid issues in which multiple data transmissions close in time use overlapping regions of the long key 122, potentially exposing values of the long key 122.

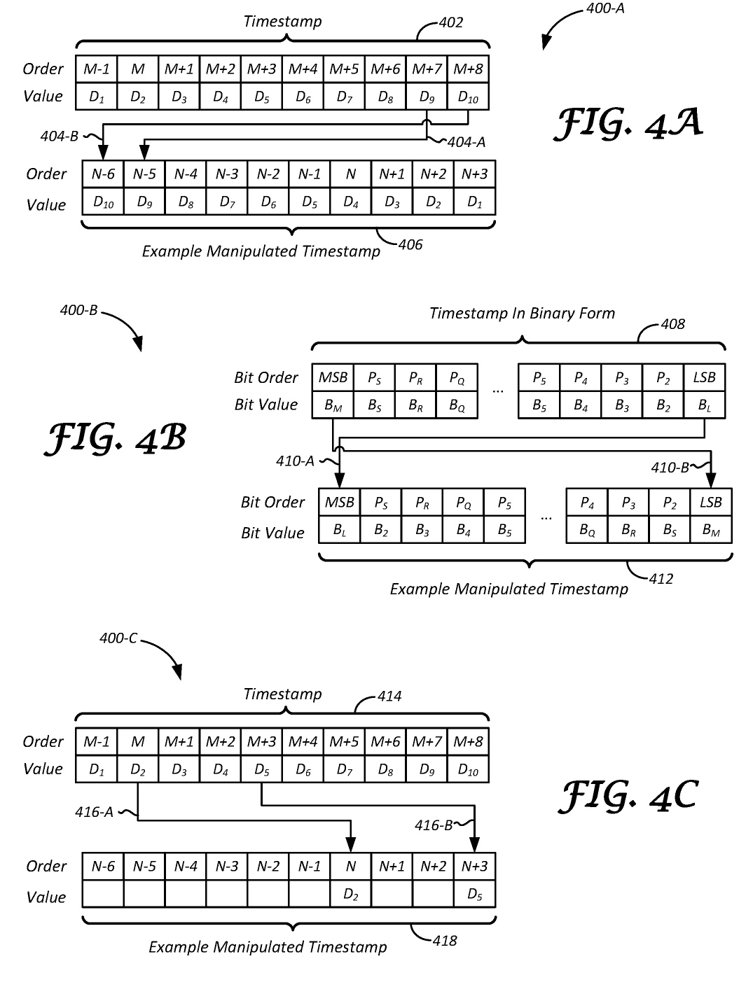

As shown in FIG. 4A, the update server 128 may in an example manipulation 400-A reverse the digit order of a decimal representation 402 of the timestamp value. For instance, the update server 128 may arrange the data of the timestamp value into base-ten decimal digits (e.g., as a sequence of digits from 0-9), and may then reverse the order of the decimal digits. For instance, the update server 128 may rearrange 404-A the last digit of the decimal representation 402 of the timestamp value to be a first digit of an example manipulated timestamp 406, rearrange 404-B the second to last digit of the decimal representation 402 to be a second digit of the example manipulated timestamp 406, and so on. Using such an approach, the update server 128 may reverse an example digit string 0324 into a corresponding reversed digit string 4230. Once reversed, the bit elements of the timestamp value may be used to generate the key offset 204.

In another example, as shown in the manipulation 400-B of FIG. 4B, the update server 128 may reverse the order of bits in a binary string 408 representation of the timestamp value. The update server 128 may, for example, place 410-A a least significant bit (LSB) of the binary string 408 to be a most significant bit (MSB) of an example manipulated timestamp 412, place 410-B an MSB of the binary string 408 to be an LSB of the example manipulated timestamp 412, and so on. Using such an approach, the update server 128 may reverse an example binary string 01110011 into a corresponding reversed binary string 11001110. Once reversed, the bit elements of the timestamp value may be used to generate the key offset 204.

The value of the long key 12 at the key offset 204 generated using a manipulated timestamp value may be a first value of the long key 122 to be used for the encryption and decryption operations. As reversing the order of the timestamp value places least significant time information into a relatively more or most significant location, reversing the order of the binary or decimal representation of the timestamp value to generate the key offset 204 for transmissions causes transmissions that are close in timestamp values to result in different first values of the long key 122, i.e., values of the long key 122 at the key offset 204, to use in the encryption and decryption operations.

In yet another example manipulation 400-C, as shown in FIG. 4C, the update server 128 may rearrange a decimal representation 414 of the timestamp value in a predetermined order known to both the vehicle 102 and the update server 128 to generate an example manipulated timestamp 418. The update server 128 may, for example, rearrange 416-A an Mth element of the decimal representation 414 of the timestamp value to be an Nth element of the example manipulated timestamp 418, an Mth+3 element of the decimal representation 414 to be an Nth+3 element of the example manipulated timestamp 418 and so on.

It should be noted that the manipulations 400-A, 400-B and 400-C are merely examples, and other manipulations, rearrangements, and repositioning of elements of the timestamp value and one or representations of the timestamp value are also contemplated. In an example, the update server 128 may generate the key offset 204 using a same predetermined manipulation or rearrangement pattern for all software update transmissions. In another example, the update server 128 may select a particular manipulation or rearrangement pattern to be used in a next software update transmission. Using this approach, the update server 128 may include the selected manipulation or rearrangement pattern with the encrypted software update 120′ transmitted to the vehicle 102. The vehicle 102 may further send a confirmation to the update server 128 in response to receiving the selected manipulation or rearrangement pattern to be used in the next software update transmission.

The update server 128 may be configured to determine the key offset 204 using the manipulated timestamp value, such as by translating the manipulated timestamp value into a byte index into an array representing the long key 122. The update server 128 may, for example, scale the manipulated timestamp value to a length in bytes of the long key 122 such that the value of the key offset 204 may be a value from zero to the number of bytes of the long key 122. In another example, the update server 128 may perform one or more modular arithmetic operations on the manipulated timestamp value to generate the key offset 204 value from zero to the number of bytes of the long key 122. It should be noted that these are merely examples, and other computing or arithmetic processes may be applied to the manipulated timestamp value to compute the key offset 204 value into the long key 122.

Having identified the long key 122 and key offset 204, the update server 128 may encrypt each byte of the software update 120 using a different byte of the long key 122. For instance, the update server 128 may generate a first byte of the encrypted software update 120′ by adding a first byte of the software update 120 to the first byte of the long key 122 at the key offset 204, and may generate the second byte of the encrypted software update 120′ by adding a second byte of the software update 120 to the second byte of the long key 122 at the key offset 204. In another example, the update server 128 may generate a first byte of the encrypted software update 120′ by XORing a first byte of the software update 120 with the first byte of the long key 122 at the key offset 204, and may generate the second byte of the encrypted software update 120′ by XORing a second byte of the software update 120 with the second byte of the long key 122 at the key offset 204. The update server 128 may continue generating of the encrypted software update 120′ in such a manner until the software update 120 is fully encrypted into the encrypted software update 120′.

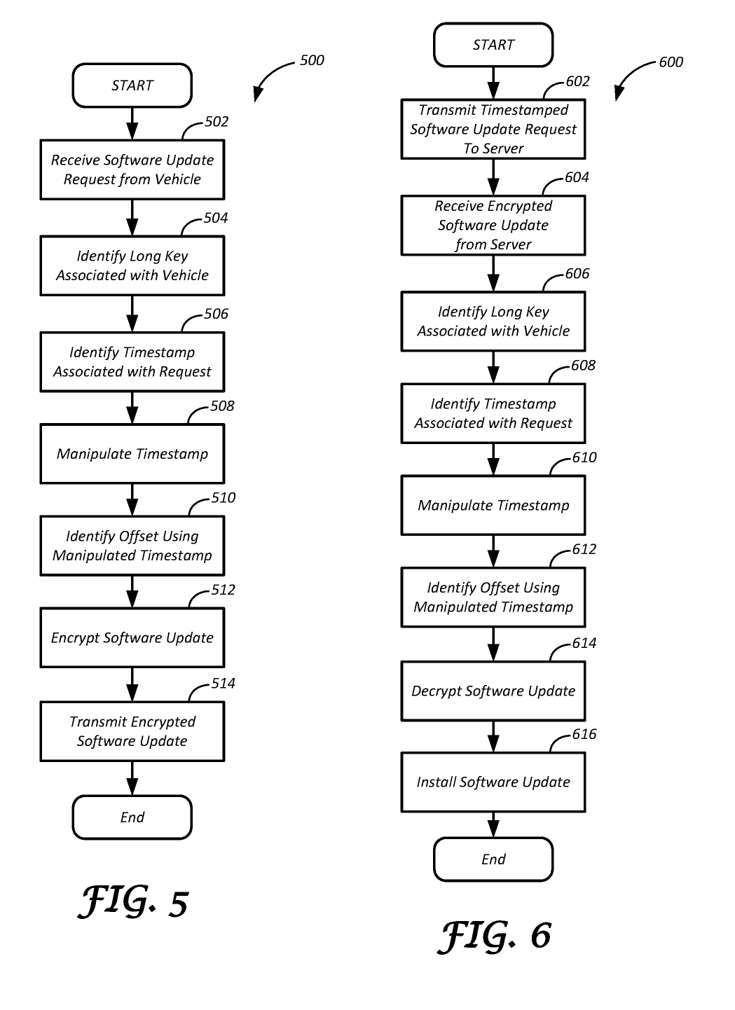

In reference to FIG. 5, an exemplary process 500 for encrypting a software update using a manipulated timestamp is shown. The process 500 may begin at block 502 where the update server 128 receives a signal from the vehicle 102 indicative of a request for the software update 120. The update server 128 identifies the long key 122 associated with the vehicle 102 at block 504. In one example, the update server 128 may communicate with the data store 130 configured to maintain the long keys 122 associated with the vehicle information 124.

The update server 128 at block 506 identifies the timestamp value associated with the request for the software update 120. In one example, the timestamp value may be a number of seconds elapsed since a predetermined epoch or instance in time and may be expressed in a decimal format. At block 508 the update server 128 manipulates the timestamp value. The update server 128 may, for example, convert the decimal representation of the timestamp value into a binary string and further rearrange the binary string according to a predetermined rearrangement or ordering. In another example, the update server 128 may reverse the order of bits in the binary string rearranging the MSB of the binary string to be the LSB.

The update server 128 at block 510 identifies the key offset 204 into the long key 122 to use for the encryption operation. The update server 128 may, for example, scale the manipulated timestamp value to generate the key offset 204 into the long key 122 to encrypt and decrypt the software update 120. In another example, the update server 128 may perform one or more modular arithmetic operations, or apply another computing or arithmetic process to the manipulated timestamp value to generate the key offset 204 into the long key 122.

At block 512 the update server 128 encrypts the software update 120 using the manipulated timestamp value. For example, the update server 128 may generate a first byte of the encrypted software update 120′ by adding or XORing a first byte of the software update 120 to the first byte of the long key 122 at the key offset 204 generated using the manipulated timestamp, and may generate the second byte of the encrypted software update 120′ by adding or XORing a second byte of the software update 120 to the second byte of the long key 122 at the key offset 204 generated using the manipulated timestamp, respectively. At block 514 the update server 128 transmits the encrypted software update 120′ to the vehicle 102. At this point the process 500 may end. In some examples, the process 500 may be repeated in response to receiving a request for the software update 120 or in response to another signal or request.

In reference to FIG. 6, an exemplary process 600 for decrypting a software update using a manipulated timestamp value is shown. The process 600 may begin at block 602 where the vehicle 102 transmits a signal to the update server 128 indicative of a request for the software update 120. At block 604 the vehicle 102 receives from the update server 128 the encrypted software update 120′. The vehicle 102 at block 606 identifies the long key 122 associated with the vehicle 102. In one example, the update application 112 may communicate with the storage 108 configured to maintain the long key 122 associated with the vehicle 102.

The vehicle 102 at block 608 identifies the timestamp value included as a field within or otherwise associated with the request for the software update 120. In one example, the timestamp value may be a decimal number of seconds elapsed between a predetermined instance in time and a time the request for the software update 120 was transmitted. At block 610 the vehicle 102 manipulates the timestamp value or manipulates a decimal or a binary representation of the timestamp value. The vehicle 102 may, for example, convert the decimal representation of the timestamp value into a binary string and further rearrange the binary string according to a predetermined order. In another example, the vehicle 102 may reverse the order of bits in the binary string rearranging the MSB of the binary string to be the LSB of the manipulated timestamp value.

The vehicle 102 at block 612 generates the key offset 204 using the manipulated timestamp value. The vehicle 102 may generate the key offset 204, for example, by scaling the manipulated timestamp value to a length of the long key 122, by performing one or more modular arithmetic operations, or applying another computing or arithmetic process to the manipulated timestamp value.

At block 614 the vehicle 102 decrypts the encrypted software update 120′ using the manipulated timestamp value. For example, the vehicle 102 may generate a first byte of the decrypted software update 120 by adding or XORing a first byte of the encrypted software update 120′ to the first byte of the long key 122 at the key offset 204, and may generate the second byte of the decrypted software update 120 by adding or XORing a second byte of the encrypted software update 120′ to the second byte of the long key 122 at the key offset 204, respectively. At block 616 the vehicle 102 installs the decrypted software update 120 on the one or more vehicle controllers 116 of the vehicle 102. At this point the process 600 may end. In some examples, the process 600 may be repeated in response to receiving, e.g., responsive to a request, the encrypted software update 120′ or in response to another signal or request.

The processes, methods, or algorithms disclosed herein may be deliverable to or implemented by a processing device, controller, or computer, which may include any existing programmable electronic controller or dedicated electronic controller. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A wireless communication system comprising:
a server, in communication with a controller of a vehicle, configured to, in response to receiving from the controller a software update request including a timestamp, identify a long key associated with the vehicle, encrypt the update beginning at a key offset into the long key generated from a manipulation of a data ordering of the timestamp, and transmit the encrypted update to the controller.

2. The system of claim 1, wherein the manipulation of the data ordering of the timestamp includes reversing a decimal representation of the timestamp.

3. The system of claim 1, wherein the manipulation of the data ordering of the timestamp includes reversing a binary representation of the timestamp.

4. The system of claim 1, wherein the manipulation of the data ordering of the timestamp includes mapping a digit order in a decimal representation of the timestamp to a manipulated representation of the timestamp according to a predetermined digit reordering.

5. The system of claim 1, wherein the manipulation of the data ordering of the timestamp is according to a predetermined pattern selected by the server and transmitted from the server to the vehicle in response to a previous software update request.

6. The system of claim 1, wherein the server is further configured to confirm that the software update request is authorized based on a determination that the timestamp of the software update request differs from timestamps associated with previous software update requests.

7. The system of claim 1, wherein the server is further configured to confirm that the software update request is authorized based on a determination that a difference in time between the timestamp of the software update request and a previous software update request timestamp is less than a predefined threshold difference in time.

8. A method comprising:
in response to receiving a request from a controller of a vehicle for a software update, identifying, by a server, a long key associated with the vehicle;
encrypting the update using data at a key offset into the long key, the key offset computed from a reordering of data elements of a timestamp of the request; and
sending the encrypted update to the controller.

9. The method of claim 8, wherein the data elements are bits, and the reordering includes reversing ordering of the bits such that a most significant bit and a least significant bit are reversed.

10. The method of claim 8, wherein the data elements are bytes, and the reordering includes reversing ordering of the bytes such that a most significant byte and a least significant byte are reversed.

11. The method of claim 8, wherein the data elements are decimal digits, and the reordering includes reversing ordering of the decimal digits such that a most significant decimal digit and a least significant decimal digit are reversed.

12. The method of claim 8, wherein the reordering includes reordering according to a predetermined pattern selected by the server and transmitted from the server to the vehicle in response to a previous update request.

13. The method of claim 8, further comprising confirming that the software update request is authorized based on a determination that the timestamp of the software update request differs from timestamps associated with previous software update requests.

14. The method of claim 8, further comprising confirming that the software update request is authorized based on a determination that a difference in time between the timestamp of the software update request and a previous software update request timestamp is less than a predefined threshold difference in time.

15. A system for a vehicle comprising:
a controller, in communication with a server, configured to, in response to receiving from the server an encrypted software update triggered by an update request transmitted by the controller and including a timestamp, identify a long key associated with the vehicle, decrypt the update beginning at a key offset into the long key generated from a manipulation of data ordering of the timestamp, and initiate an installation of the decrypted update on the vehicle.

16. The system of claim 15, wherein the manipulation of the data ordering of the timestamp includes reversing a digit order in a decimal representation of the timestamp.

17. The system of claim 15, wherein the manipulation of the data ordering of the timestamp includes reversing a bit order in a binary representation of the timestamp.

18. The system of claim 15, wherein the manipulation of the data ordering of the timestamp includes mapping a digit order in a decimal representation of the timestamp to a manipulated representation of the timestamp according to a predetermined digit reordering.

19. The system of claim 15, wherein the manipulation of the data ordering of the timestamp is according to a predetermined pattern selected by and received from the server with a previous encrypted software update.

20. The system of claim 15, wherein the controller is further configured to determine the key offset by scaling the manipulation of the data ordering of the timestamp to correspond to a length of the long key.
